(19) United States
(12) Patent Application Publication
(10) Pub. No.: US 2006/0012131 A1
(43) Pub. Date: Jan. 19, 2006

(54) Fluid aperture with stopper bead

(76) Inventors: Frank W. Popielas, Plainfield, IL (US); Edward A. Raden, Downers Grove, IL (US); Rohit Ramkumar, Romeoville, IL (US); Colin C. Chen, Barrington, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/182,395

(22) Filed: Jul. 15, 2005

Related U.S. Application Data
(60) Provisional application No. 60/588,451, filed on Jul. 16, 2004.

(51) Int. Cl. F02F 11/00

(52) U.S. Cl. 277/595

(57) ABSTRACT

A gasket includes first and second metal layers having at least one opening formed therein. A half sealing bead surrounds the periphery of said opening. A support bead is formed adjacent to said half sealing bead to prevent crushing of the half sealing bead during engine operation.

### CROSS REFERENCE TO RELATED APPLICATIONS

This application claims the benefit of U.S. Provisional Application Ser. No. 60/588,451 filed Jul. 16, 2004 which is hereby incorporated by reference in its entirety.

### BACKGROUND

The present invention relates generally to improvements in multi-layered steel (MLS) cylinder head gaskets for automotive internal combustion engines. More specifically, the present invention relates to an MLS gasket having a protective sealing bead around a fluid aperture in the gasket.

In recent years, MLS cylinder head gaskets have become a preferred design, wherein all (typically at least two) gasket layers have been formed from steel. In a typical MLS gasket design, the gasket is provided with a plurality of openings. More specifically, known gaskets include cylinder bore openings, water holes, bolt holes and oil holes. The bolt holes, which are generally located around the periphery of the gasket, cooperate with bolts to secure the gasket between the cylinder head and engine block. The cylinder bore openings, water holes and oil holes are sealed by surface pressures formed by the clamping action of the bolts.

Generally, when the bolts are tightened, the surface pressures varies throughout the sealing joint, especially the areas surrounding the other fluid openings, such as oil holes, do not have equal surface pressures formed therearound.

With respect to oil holes, for example, to compensate for unequal surface pressures, one solution has been to provide a half bead around the periphery of the oil hole. However, during extreme operating conditions, the half bead becomes crushed between the cylinder head and engine block, thereby destroying recovery potential, and hence the sealing effectiveness of the half bead. As a result, leaks are still experienced. Therefore, there is a need to provide a sealing mechanism that prevents the half bead from being damaged or destroyed, while eliminating potential leaks.

### SUMMARY

An embodiment of the present invention is directed to a multi-layered cylinder head gasket having at least two metal layers. Each of the metal layers is formed with a plurality of openings. The layers are positioned in a stacked relationship to form the gasket. When stacked, the plurality of openings formed in the metal layers become aligned. A half sealing bead that extends outwardly from upper and lower surfaces of the gasket surrounds a periphery of at least one of the aligned openings. A support bead is positioned adjacent to the half sealing bead and away from the periphery of the aligned openings.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope of the disclosure.

FIG. 1 is a plan view of one embodiment of an MLS cylinder head gasket in accordance with the present invention;

FIG. 2 is an enlarged plan view of a fragmentary portion marked as area 2 of the gasket of FIG. 1;

FIG. 3 is a cross sectional view of an oil opening formed in the MLS gasket taken along lines 3-3 of FIG. 2.

### DETAILED DESCRIPTION

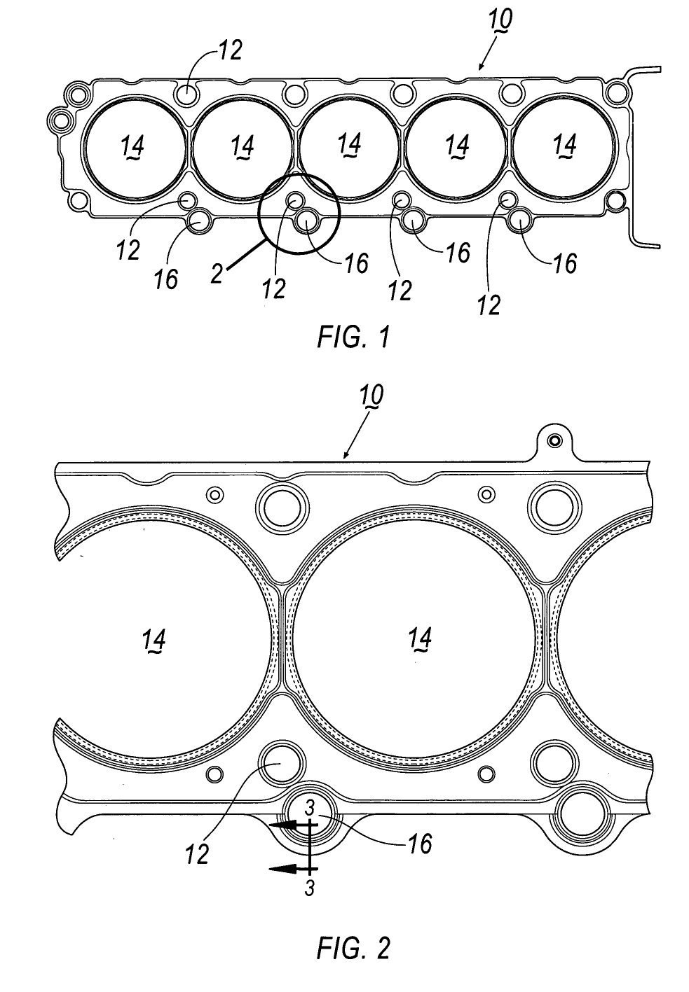

As seen in FIG. 1, the gasket of the present invention is generally referred to at 10. The gasket 10 includes a plurality of apertures such as bolt holes 12, combustion openings 14 that mate with corresponding apertures of a cylinder head (not shown) and cylinder block (not shown), and oil holes 16. When fully assembled, the gasket 10 is positioned between the cylinder head and cylinder block to fill gaps and seal around various holes and openings 12, 14, and 16. The seal generated by gasket 10 serves to prevent leaks and contamination.

Gaps between the cylinder head and cylinder block are created when fasteners (not shown) such as a bolt are positioned through bolt holes 12, and are tightened to mate the cylinder head and cylinder block. These gaps result in unequal sealing stresses around the bolt holes 12, the combustion openings 14, the oil holes 16, and other fluid apertures (not shown). Furthermore, the gasket 10 is subject to high loads in compression. The high compression loading generates higher stresses that may result in failure of the gasket 10, such as cracking. An exemplary embodiment of the present invention will herein be described with attention to the sealing stresses generated about the oil holes 16. However, gasket 10 of the present invention may incorporate the described features about any aperture. Furthermore, various embodiments of the multi-layered gasket 10 are shown throughout the Figures and similar reference numerals are used throughout FIGS. 1-3.

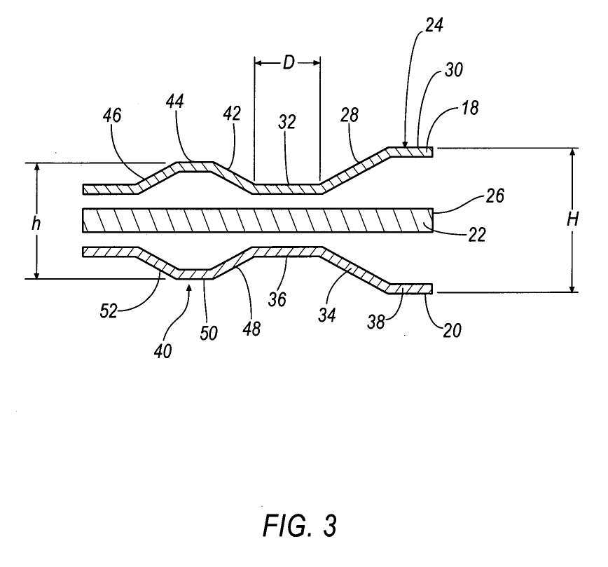

As shown more clearly in FIGS. 2 and 3, gasket 10 is a multi-layered gasket 10 having at least a first metal layer 18 and a second metal layer 20. Gasket 10 preferably further includes a third metal layer 22. Third layer 22 is a relatively thick metal layer, and is generally called a spacer layer. Third layer 22 is sandwiched between first and second metal layers 18, 20. First and second metal layers 18, 20 are relatively thin in comparison with third layer 22 and are preferably constructed of 301 stainless steel, a relatively robust metal with a high spring rate for meeting requisite performance requirements over a useful gasket life. Third layer 22 is preferably formed of a less robust metal, such as 409 stainless steel, or in some cases even zinc-plated or plain low carbon steels. Each of the metal layers 18, 20, 22 include corresponding combustion bore openings 14, bolt holes 12 and oil holes 16 formed therein such that all of the holes and openings of each gasket layer 18, 20, 22 align when assembled into gasket 10.

As shown best in FIG. 3, an oil hole 16 is positioned adjacent bolt hole 12. To address the uneven sealing pressures created by the bolt hole 12, oil hole 16 is provided with a half bead 24 that surrounds the periphery 26 of oil hole 16. Half bead 24 is formed by first metal layer 18 in cooperation with second metal layer 20. First metal layer 18 includes an upwardly extending leg portion 28 that terminates in a generally laterally extending foot portion 30, such that half bead 24 is raised upwardly from a top surface 32 of first metal layer 18. Foot portion 30 extends to the periphery 26 of oil hole 16.

Second metal layer 20 includes a leg portion 34 that extends downwardly from a bottom surface 36 of second metal layer 20. Leg portion 34 terminates in generally laterally extending foot portion 38. The leg portions 28, 34 and foot portions 30, 38 of first and second plates 18, 20 cooperate to form half bead 24. The length of leg portions 28, 34 are selected to obtain a predetermined bead height H to provide the appropriate level of sealing for oil hole 16.

In accordance with another aspect of the invention, gasket 10 may further be provided with a support bead 40 that is positioned outbound of oil hole 16 adjacent to half bead 24. In one preferred embodiment, support bead 40 is spaced from half bead 24 by a predetermined distance D. Similar to half bead 24, support bead 40 is formed by first metal layer 18 in cooperation with second metal layer 20. More specifically, first metal layer 18 includes a first leg portion 42 that extends upwardly from top surface 32 of first metal layer 18. First leg portion 42 terminates in a generally planar apex portion 44. Connected to generally planar apex portion 44 opposite first leg portion 42 is a second leg portion 46 that extends downwardly from generally planar apex portion 44 in a similar manner as first leg portion 42.

Second metal layer 20 includes a first leg portion 48 that extends downwardly from bottom surface 36 of second metal layer 20 and terminates in a generally planar base portion 50. Connected to generally planar base portion 50 opposite first leg portion 48 is an upwardly extending second leg portion 52. The leg portions 42, 46, 48, and 52 and apex and base portions 44 and 50, of first and second plates 18, 20 cooperate to form support bead 40.

In accordance with one aspect of one embodiment, the length of leg portions 42, 46, 48, and 52 are selected to obtain a predetermined bead height h to provide the appropriate level of sealing for oil hole 16, without compromising the sealing characteristics of half bead 24. More specifically, support bead 40 is formed so as to have a height h that is somewhat less than the bead height H of half bead 24. Thus, support bead 40, which extends outwardly from the outer surfaces 32, 36 of first and second metal plates 18, 20 in opposite directions is stiff enough to limit crushing of half bead 24 between the engine block and the cylinder head, thereby preserving the recovery characteristics of half bead 24 during thermal expansions and contractions. In one embodiment, support bead 40 extends at least partially around half bead 24. In another embodiment, support bead 40 extends completely around half bead 24.

Because cylinder heads and engine blocks for different engines have different thermal effects, the appropriate height and load deflection behavior of the support bead 40 are critical. First, the sealing pressure of the gasket 10 and in particular the area around the oil holes 16 needs be determined. Finite element analysis is one desirable method to accomplish this step. This determination step will estimate the load required to support the half bead 24 around the oil hole 16 such that half bead 24 does not become crushed. Once the load required is estimated, the specific geometry of the support bead 40 may be determined. Accordingly, support bead 40 may be individually tuned to fit a specific application, without resorting to undue experimentation.

It is to be understood that the above description is intended to be illustrative and not limiting. Many embodiments will be apparent to those skilled in the art upon reading the above description. The scope of the invention should be determined, however, not with reference to the above description, but with reference to the appended claims with full scope of equivalents to which such claims are entitled.

What is claimed is:

1. A cylinder head gasket comprising:
a first metal layer having a plurality of openings formed therein;
a second metal layer having a plurality of openings formed therein, wherein said plurality of openings of said second metal layer corresponds to said plurality of openings of said first metal layer;
wherein said first metal layer and said second metal layer are positioned in a stacked relationship to form said gasket and defining an upper surface and a lower surface and said openings are aligned;
wherein said stacked together first and second metal layers further include a half sealing bead that extends outwardly from said upper and lower surfaces, said half sealing bead surrounding a periphery of at least one of said aligned openings;
wherein said stacked together first and second metal layers further include a support bead positioned adjacent said half sealing bead away from said periphery of said aligned openings.

2. The gasket of claim 1, wherein said at least one of said aligned openings is an oil hole.

3. The gasket of claim 1, wherein said at least one of said aligned openings is a coolant hole.

4. The gasket of claim 1, wherein said support bead is spaced away from said half bead by a predetermined distance.

5. The gasket of claim 1, wherein said support bead extends completely around said half bead.

6. The gasket of claim 1, wherein said support bead extends partially around said half bead.

7. The gasket of claim 6, wherein said support bead extends only half way around said half bead.

8. The gasket of claim 1, wherein said half bead has a first predetermined height and said support bead has a second predetermined height, whereby said first predetermined height is greater than said second predetermined height.

9. The gasket of claim 1, wherein said first metal layer includes a leg portion that extends upwardly from a top surface of said first metal layer and terminates in a foot portion and wherein said second metal layer includes a leg portion that extends downwardly from a bottom surface of said second metal layer and terminates in a foot portion, said leg portions and foot portions of said first and second metal layers cooperating to form said half bead.

10. The gasket of claim 1, wherein said foot portions are generally planar.

11. The gasket of claim 1, wherein said first metal layer includes a first leg portion that extends upwardly from a top surface of said first metal layer and terminates in an apex portion and a second leg portion that extends downwardly from said apex portion opposite said first leg portion; and
wherein said second metal layer includes a first leg portion that extends downwardly from a bottom surface of said second metal layer and terminates in a base portion and a second leg portion that extends upwardly from said base portion opposite said first leg portion, said leg portions and apex and base portions of said first and second metal layers cooperating to form said support bead.

12. The gasket of claim 1, further comprising a spacer layer positioned between said first and second metal layers, said spacer layer having openings corresponding to the openings in said first and second metal layers.

13. A cylinder head gasket comprising:
a first metal layer having a plurality of openings formed therein;
a second metal layer having a plurality of openings formed therein, wherein said plurality of openings of said second metal layer corresponds to said plurality of openings of said first metal layer;
wherein at least one of said openings is a fluid opening;
wherein said first metal layer and said second metal layer are positioned in a stacked relationship to form said gasket and defining an upper surface and a lower surface and said openings are aligned;
wherein said stacked together first and second metal layers further include a half sealing bead that extends outwardly from said upper and lower surfaces, said half sealing bead surrounding a periphery of said fluid opening;
wherein said stacked together first and second metal layers further include a support bead; said support bead being positioned a predetermined distance from said half bead and is positioned away from said periphery of said fluid opening.

14. The gasket of claim 13, wherein said support bead extends partially around said half bead.

15. The gasket of claim 14, wherein said support bead extends only half way around said half bead.

16. The gasket of claim 13, wherein said support bead extends completely around said half bead.

17. The gasket of claim 13, wherein said half bead has a first predetermined height and said support bead has a second predetermined height, whereby said first predetermined height is greater than said second predetermined height.

18. The gasket of claim 13, wherein said first metal layer includes a leg portion that extends upwardly from a top surface of said first metal layer and terminates in a generally planar foot portion and wherein said second metal layer includes a leg portion that extends downwardly from a bottom surface of said second metal layer and terminates in a generally planar foot portion, said leg portions and foot portions of said first and second metal layers cooperating to form said half bead.

19. The gasket of claim 13, wherein said first metal layer includes a first leg portion that extends upwardly from a top surface of said first metal layer and terminates in an apex portion and a second leg portion that extends downwardly from said apex portion opposite said first leg portion; and
wherein said second metal layer includes a first leg portion that extends downwardly from a bottom surface of said second metal layer and terminates in a base portion and a second leg portion that extends upwardly from said base portion opposite said first leg portion, said leg portions and apex and base portions of said first and second metal layers cooperating to form said support bead.

20. The gasket of claim 13, further comprising a spacer layer positioned between said first and second metal layers, said spacer layer having openings corresponding to the openings in said first and second metal layers.
